(19) United States
(12) Patent Application Publication
(10) Pub. No.: US 2019/0132918 A1
(43) Pub. Date: May 2, 2019

(54) CONTROLLER, LIGHT SOURCE DRIVING CIRCUIT AND METHOD FOR CONTROLLING LIGHT SOURCE MODULE

(71) Applicant: O2Micro, Inc., Santa Clara, CA (US)

(72) Inventors: Min XU, Chengdu (CN); Jun REN, Chengdu (CN); Zhimou REN, Chengdu (CN)

(21) Appl. No.: 16/146,911

(22) Filed: Sep. 28, 2018

(30) Foreign Application Priority Data
Oct. 27, 2017 (CN) 201711027542.8

(51) Int. Cl. H05B 33/08; H05B 37/02

(52) U.S. Cl. CPC H05B 33/0815; H05B 37/0281; H05B 33/0887

(57) ABSTRACT

A controller is coupled to a first light source in a light source module through a power converter. The controller includes a monitoring terminal and a control terminal. The monitoring terminal is coupled to a power switch and is operable for receiving a switch monitoring signal indicating an on/off state of the power switch. The power switch is coupled between a power source and a rectifier. The power converter is operable for receiving input electric power from the rectifier and for supplying electric power to the first light source. A control terminal is operable for outputting an enable signal based on the switch monitoring signal to control a second controller coupled to a second light source in the light source module to turn on and turn off the second light source.

### RELATED APPLICATION

This application claims priority to Chinese Patent Application No. 201711027542.8, titled “Controller, Light Source Driving Circuit and Method for Controlling Light Source Module,” filed on Oct. 27, 2017, with the National Intellectual Property Administration of the People's Republic of China (CNIPA).

### BACKGROUND

Compared with traditional incandescent lamps, light-emitting diode (LED) light sources offer several advantages such as low power conservation, environmental friendliness, high power efficiency, long lifespan, and so on. Therefore, there is a trend to replace incandescent lamps with LED light sources. An LED bulb is one type of LED lamp. An LED bulb has a shape and size similar to those of traditional incandescent lamps. LED light sources and control chips are integrated within an LED bulb. Conventional light switches (e.g., conventional on/off dimmers) can only control the on/off state of LED lamps, and cannot adjust the color and the brightness of LED lamps. Thus, conventionally, a special switch or a remote control is needed to regulate the color and the brightness of LED light sources.

### SUMMARY

Embodiments in accordance with the present invention provide a controller, a light source driving circuit, and a method for controlling a light source module.

In embodiments, a controller is coupled to a first light source in a light source module through a power converter. The controller includes a monitoring terminal and a control terminal. The monitoring terminal is coupled to a power switch and is operable for receiving a switch monitoring signal indicating an on/off state of the power switch. The power switch is coupled between a power source and a rectifier. The power converter is operable for receiving input electric power from the rectifier and for supplying electric power to the first light source. A control terminal is operable for outputting an enable signal based on the switch monitoring signal to control a second controller coupled to a second light source in the light source module, the second controller operable to turn on the second light source, the second controller also operable to turn off the second light source.

In embodiments, a light source driving circuit includes a light source module, a first power converter, a second power converter, a first controller coupled to the first power converter, and a second controller coupled to the second power converter. The light source module includes a first light source and a second light source. The light source module has a number of modes. The first power converter is operable for receiving input electric power from a rectifier and for supplying output electric power to the first light source. The second power converter is operable for receiving input electric power from the rectifier and for supplying output electric power to the second light source. The first controller is operable for: controlling the first light source by controlling the first power converter, receiving a switch monitoring signal indicating an on/off state of a power switch, and controlling a mode of the light source module based on the switch monitoring signal. The second controller is operable for controlling the second light source by controlling the second power converter. An on/off state of the second controller is determined by an enable signal output by the first controller.

In embodiments, a method for controlling a light source module that includes a first light source and a second light source includes the following steps: powering the light source module by electric power output by a power converter, where the light source module has a number of modes; receiving a switch monitoring signal indicating an on/off state of a power switch by a first controller, where the power switch is coupled between a power source and the power converter; controlling a mode of the light source module based on the switch monitoring signal by the first controller; switching the mode of the light source module from a first mode to a second mode by the first controller; and resetting the mode of the light source module to a default mode by the first controller when the switch monitoring signal indicates that the power switch is turned on again after a preset time period expires.

### BRIEF DESCRIPTION OF THE DRAWINGS

Features and advantages of embodiments of the present invention will become apparent as the following detailed description proceeds, and upon reference to the drawings, wherein like numerals depict like parts, and in which:

FIG. 1 shows a diagram illustrating a light source driving circuit, in accordance with an embodiment of the present invention.

FIG. 2 shows a diagram illustrating a light source driving circuit, in accordance with an embodiment of the present invention.

FIG. 3 shows a diagram illustrating a first controller, in accordance with an embodiment of the present invention.

FIG. 4 shows a diagram illustrating a mode control unit, in accordance with an embodiment of the present invention.

FIG. 5 shows a diagram illustrating a logic unit, in accordance with an embodiment of the present invention.

FIG. 6 shows a diagram illustrating a cascade control unit, in accordance with an embodiment of the present invention.

FIG. 7 shows a diagram illustrating operation of a light source driving circuit, in accordance with an embodiment of the present invention.

FIG. 8 shows a diagram illustrating operation of a light source driving circuit, in accordance with an embodiment of the present invention.

FIG. 9 shows a flowchart of a method for controlling power of a light source module, in accordance with an embodiment of the present invention.

FIG. 10 shows a flowchart of a method for controlling power of a light source module, in accordance with an embodiment of the present invention.

### DETAILED DESCRIPTION

Reference will now be made in detail to the embodiments of the present invention. While the invention will be described in combination with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

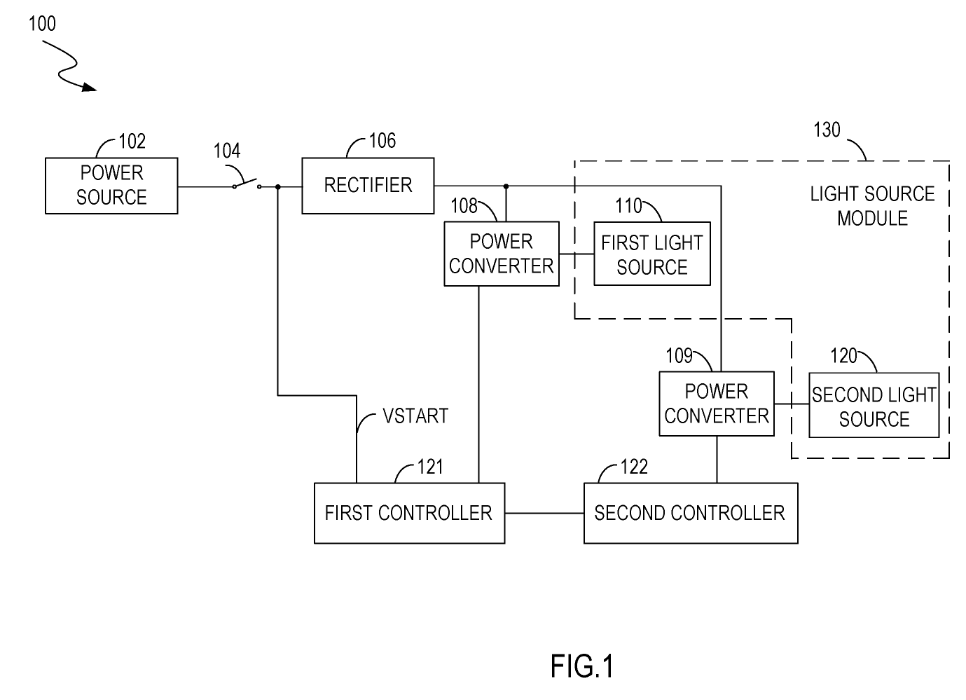

FIG. 1 shows a diagram illustrating a light source driving circuit 100, in accordance with an embodiment of the present invention. The light source driving circuit 100 includes a light source module 130. The light source module 130 includes a first light source 110 and a second light source 120. In an embodiment, the first light source 110 and the second light source 120 are LED strings with different colors relative to each other. In another embodiment, the first light source 110 and the second light source 120 are LED strings with different levels of brightness relative to each other. The light source module 130 can have multiple modes when and while it is turned on according to the on/off states of the first light source 110 and the second light source 120. For example, when turned on, the light source module 130 can be in mode A, mode B, or mode C, wherein mode A is a default mode. In mode A, the first light source 110 is turned on and the second light source 120 is turned off. In mode B, the first light source 110 is turned off and the second light source 120 is turned on. In mode C, both the first light source 110 and the second light source 120 are turned on.

The light source driving circuit 100 further includes a first controller 121, a second controller 122, a first power converter 108, and a second power converter 109. The first power converter 108 is operable for receiving input electric power from a rectifier 106, and for supplying output electric power to the first light source 110 under the control of the first controller 121. The second power converter 109 is operable for receiving input electric power from the rectifier 106, and for supplying output electric power to the second light source 120 under the control of the second controller 122. Moreover, the first controller 121 is operable for receiving a switch monitoring signal VSTART indicating an on/off state of a power switch 104, and for controlling the mode of the light source module 130 based on the switch monitoring signal VSTART. The power switch 104 is coupled between a power source 102 and the rectifier 106. If the power switch 104 is turned on, electric power flows from the power source 102 to the rectifier 106, then to the first power converter 108 and the second power converter 109. If the switch monitoring signal VSTART indicates that the power switch 104 is turned on again within a preset time period T_{SET} after it is turned off, then the first controller 121 switches the mode of the light source module 130 from a first mode to a second mode according to a predetermined order (e.g., from mode A to mode B, or from mode B to mode C, or from mode C to mode A). If the switch monitoring signal VSTART indicates that the power switch 104 is turned off then turned on again after a preset time period T_{SET} expires, then the first controller 121 resets the mode of the light source module 130 to the default mode (e.g., from any mode to mode A).

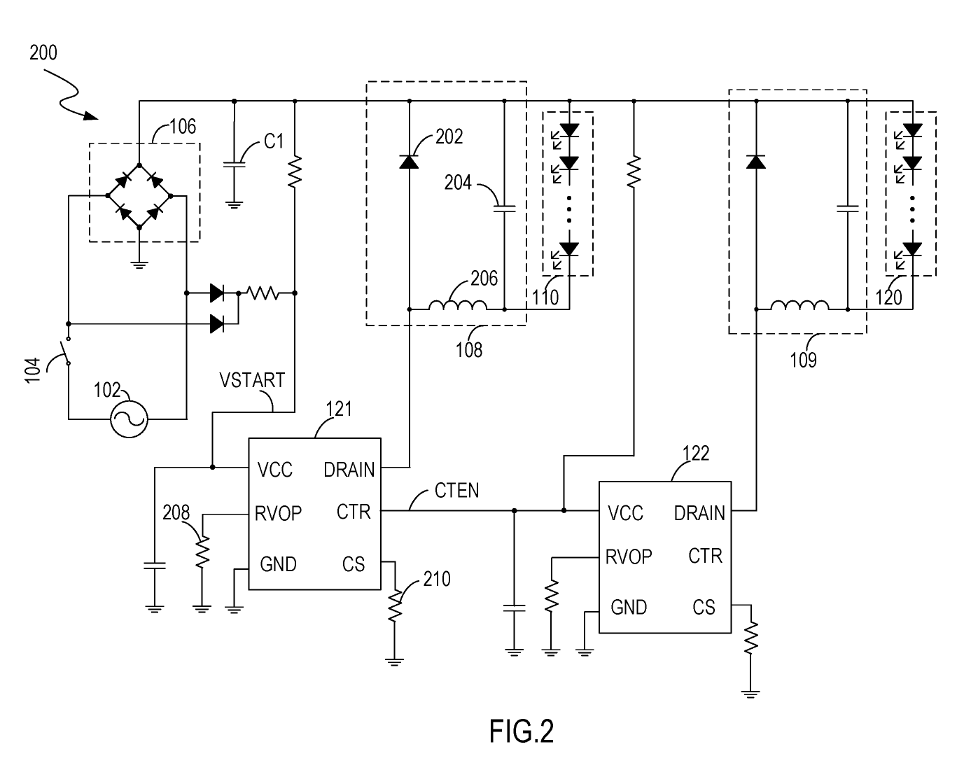

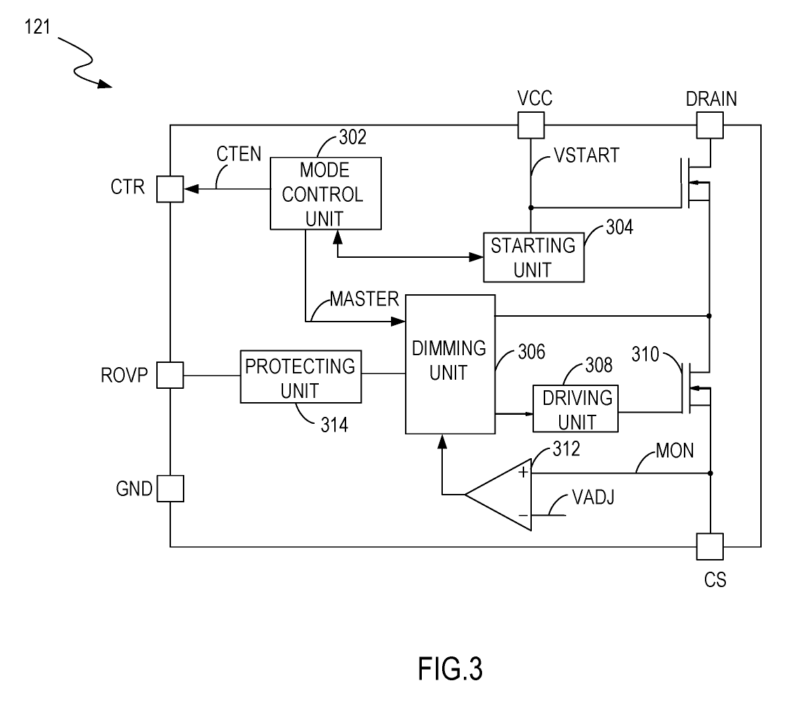

FIG. 2 shows a diagram illustrating a light source driving circuit 200, in accordance with an embodiment of the present invention. Elements labeled the same as in FIG. 1 have similar functions. The light source driving circuit 200 includes the first power converter 108 powering the first light source 110 under the control of the first controller 121, and also includes the second power converter 109 powering the second light source 120 under the control of the second controller 122. In the example of FIG. 2, the first power converter 108 and the second power converter 109 are each a buck converter. For example, the first power converter 108 includes a diode 202, a capacitor 204, and an inductor 206, and the second power converter 109 is similarly configured. In an embodiment, a switch 310 (shown in FIG. 3) is coupled in series with the first light source 110. In the embodiment of FIG. 3, the switch 310 is integrated in the first controller 121. In another embodiment, the switch 310 is coupled in series with the first light source 110 but is located outside the first controller 121.

Continuing with reference to FIG. 2, both the first power converter 108 and the second power converter 109 receive electric power from the power source 102 through the rectifier 106 (e.g., a bridge rectifier) and the power switch 104. The first power converter 108 powers the first light source 110, and the second power converter 109 powers the second light source 120. The first controller 121 controls the first light source 110 by controlling the first power converter 108. The second controller 122 controls the second light source 120 by controlling the second power converter 109. Moreover, the first controller 121 controls the mode of the light source module 130 based on the on/off state of the power switch 104 indicated by the switch monitoring signal VSTART. The light source module 130 includes the first light source 110 and the second light source 120.

In the example of FIG. 2, the terminals of the first controller 121 include a monitoring terminal VCC, a control terminal CTR, a terminal RVOP, a terminal DRAIN, a terminal CS, and a terminal GND. The monitoring terminal VCC is coupled to the power switch 104 and is operable for receiving the switch monitoring signal VSTART indicating the on/off state of the power switch 104. In an embodiment, the switch monitoring signal VSTART is a voltage at the monitoring terminal VCC. The monitoring terminal VCC also acts as a power terminal of the first controller 121 and receives electric power from the power source 102 through the switch monitoring signal VSTART. The control terminal CTR is coupled to the second controller 122, and outputs an enable signal CTEN based on the switch monitoring signal VSTART to control the second controller 122, the second controller is operable to turn on the second light source, the second controller is also operable to turn off the second light source 120. In the example of FIG. 2, the inner structure of the second controller 122 is similar to that of the first controller 121. The on/off state of the second controller 122 is determined by the voltage at the power terminal VCC. The control terminal CTR of the first controller 121 is coupled to the power terminal VCC of the second controller 122, and outputs the enable signal CTEN to the power terminal VCC of the second controller 122. When the enable signal CTEN is in a first state (e.g., 0 V), the voltage at the power terminal VCC of the second controller 122 is pulled down, and the second controller 122 is turned off accordingly. The terminal RVOP is coupled to ground through a resistor 208, and an overvoltage protection threshold of the second controller 122 is determined by the resistance of the resistor 208. The terminal GND is coupled to ground. The terminal DRAIN is coupled to the first power converter 108. The terminal CS is coupled to ground through a resistor 210. In another embodiment, the inner structure of the second controller 122 is different from that of the first controller 121, and the on/off state of the second controller 122 is determined by the voltage at the power terminal VCC.

FIG. 3 shows a diagram illustrating the first controller 121, in accordance with an embodiment of the present invention. In the example of FIG. 3, the first controller 121 includes a starting unit 304 coupled to the monitoring terminal VCC, a mode control unit 302 coupled to the control terminal CTR, a protecting unit 314 coupled to the terminal ROVP, a dimming unit 306 coupled to the protecting unit 314 and the mode control unit 302, the switch 310 coupled in series between the terminal DRAIN and the terminal CS, a driving unit 308 coupled between the dimming unit 306 and the switch 310, and a comparator 312 coupled between the terminal CS and the dimming unit 306.

The starting unit 304 is operable for selectively starting some or all units in the first controller 121 based on the voltage at the monitoring terminal VCC. A positive terminal of the comparator 312 is coupled to the terminal CS and receives a monitoring signal MON indicating a current flowing through the first light source 110. A negative terminal of the comparator 312 receives a reference signal VADJ indicating a current flowing through the first light source 110. An output terminal of the comparator 312 is coupled to the dimming unit 306. The mode control unit 302 is coupled to the monitoring terminal VCC through the starting unit 304, receives the switch monitoring signal VSTART through the starting unit 304, generates the enable signal CTEN to control the second controller 122 based on the switch monitoring signal VSTART, and generates a first control signal MASTER to control the first light source 110. The dimming unit 306 turns on or turns off the switch 310 based on the first control signal MASTER, to turn on or turn off the first light source 110 accordingly. When the first light source 110 is turned on, the dimming unit 306 generates a driving signal based on the output of the comparator 312. The driving signal controls the switch 310 through the driving unit 308. A current flowing through the first light source 110 is regulated to a target value determined by the reference signal VADJ. The protecting unit 314 controls the dimming unit 306 based on the overvoltage protection threshold determined by the resistor 208 (shown in FIG. 2) to realize overvoltage protection.

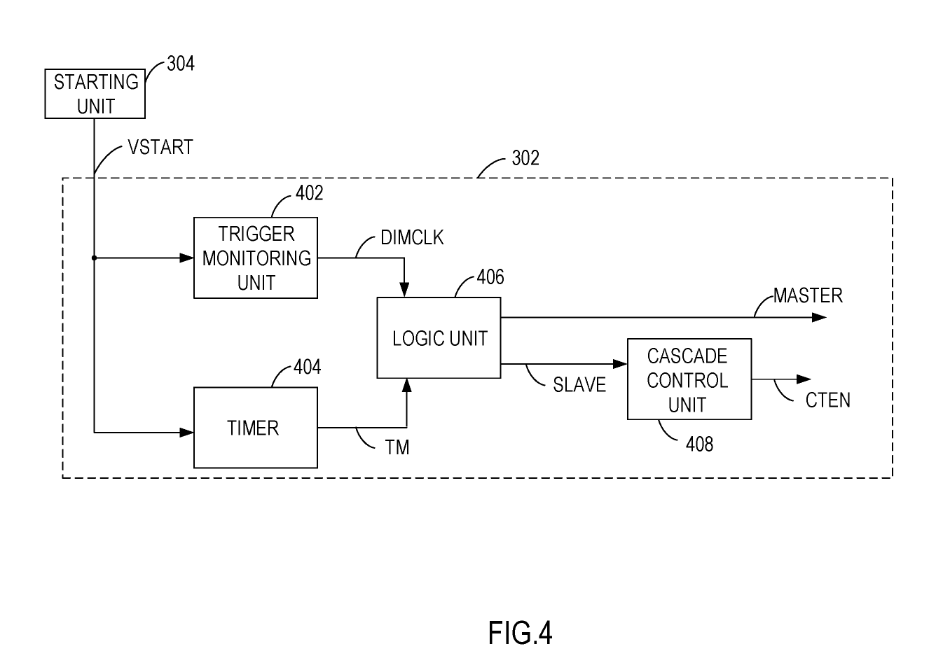

FIG. 4 shows a diagram illustrating the mode control unit 302, in accordance with an embodiment of the present invention. In an embodiment, the mode control unit 302 includes a trigger monitoring unit 402, a timer 404, a logic unit 406, and a cascade control unit 408. The trigger monitoring unit 402 generates a trigger signal DIMCLK based on the switch monitoring signal VSTART received from the starting unit 304. In an embodiment, when the power switch 104 is turned off, a negative pulse appears in the trigger signal DIMCLK. The timer 404 is operable for recording a time interval between a time the power switch 104 is turned off and a time the power switch 104 is turned on again based on the switch monitoring signal VSTART, and is also operable for generating a timing signal TM. The logic unit 406 is operable for generating the first control signal MASTER and a second control signal SLAVE based on the trigger signal DIMCLK and the timing signal TM, and regulates the mode of the light source 130 accordingly. In an embodiment, if the timer 404 indicates that the time interval between the time the power switch 104 is turned off and the time the power switch 104 is turned on again is less than the preset time period T_{SET} based on the switch monitoring signal VSTART (e.g., the power switch 104 is turned on again within the preset time period T_{SET} after it is turned off), then the timing signal TM is in a first state (e.g., at the low level). If the timer 404 indicates that the time interval between the time the power switch 104 is turned off and the time the power switch 104 is turned on again is greater than the preset time period T_{SET} based on the switch monitoring signal VSTART (e.g., the power switch 104 is turned on again after the preset time period T_{SET} expires after the power switch is turned off), the timing signal TM is in a second state (e.g., at the high level). The first control signal MASTER is operable for controlling the on/off state of the first light source 110. The second control signal SLAVE is operable for controlling the on/off state of the second controller 122, and in turn for controlling the on/off state of the second light source 120. More specifically, the cascade control unit 408 generates the enable signal CTEN based on the second control signal SLAVE, and outputs the enable signal CTEN to the power terminal VCC of the second controller 122 to control the second controller 122, the second controller 122 is operable to turn on the second light source, the second controller is also operable to turn off the second light source 120.

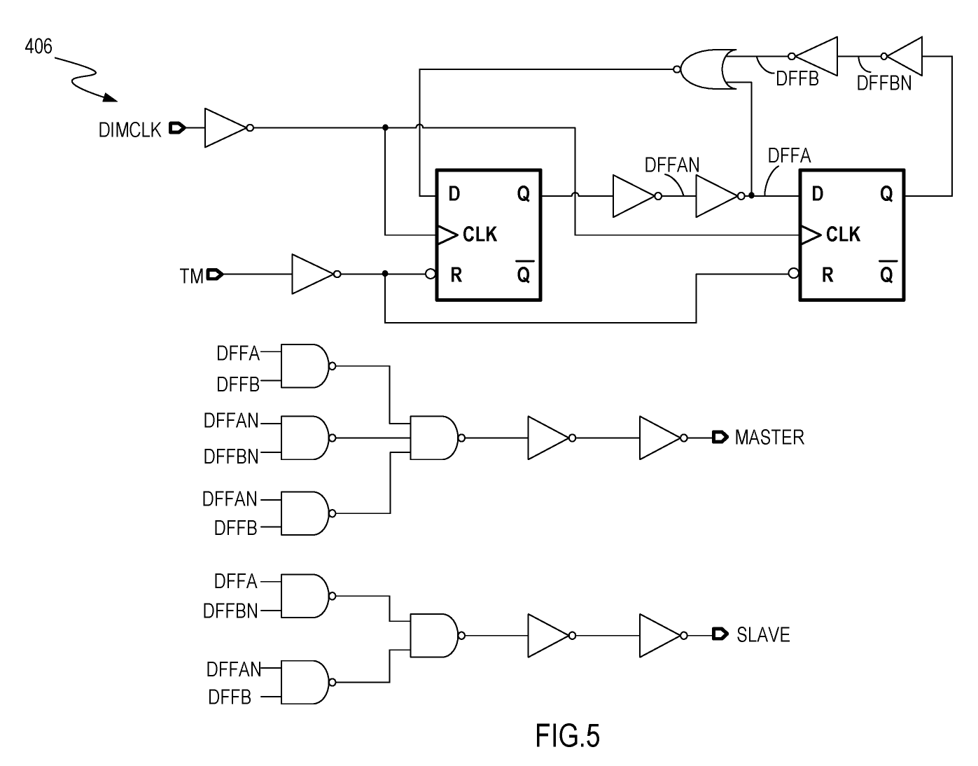

FIG. 5 shows a diagram illustrating the logic unit 406, in accordance with an embodiment of the present invention. The input signals of the logic unit 406 include the trigger signal DIMCLK and the timing signal TM. The output signals of the logic unit 406 include the first control signal MASTER and the second control signal SLAVE. Each time the power switch 104 is turned off and then turned on again within the preset time period (e.g., the timing signal TM is in the first state, such as at a low level), the logic unit 406 regulates the first control signal MASTER and the second control signal SLAVE to change the mode of the light source module 130 successively according to the predetermined order as described above; for example, the mode of the light source module 130 is changed from the first mode to the second mode according to the predetermined order as described above. If, after the power switch 104 is turned off, it is turned on again after the preset time period expires (e.g., the timing signal TM is in the second state, such as at a high level), then the logic unit 406 regulates the first control signal MASTER and the second control signal SLAVE to change (reset) the mode of the light source module 130 to the default mode (e.g., mode A).

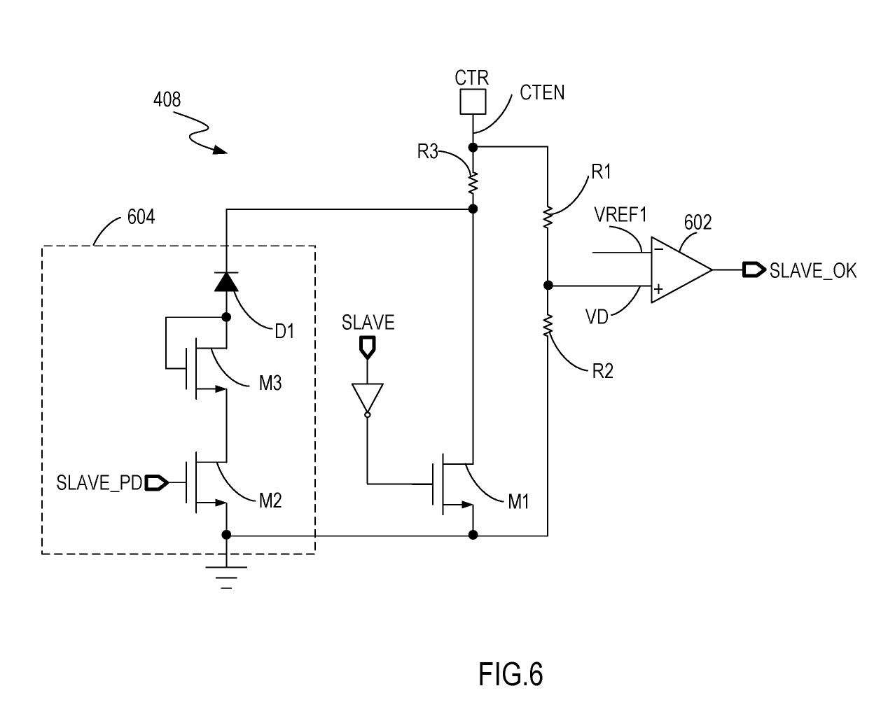

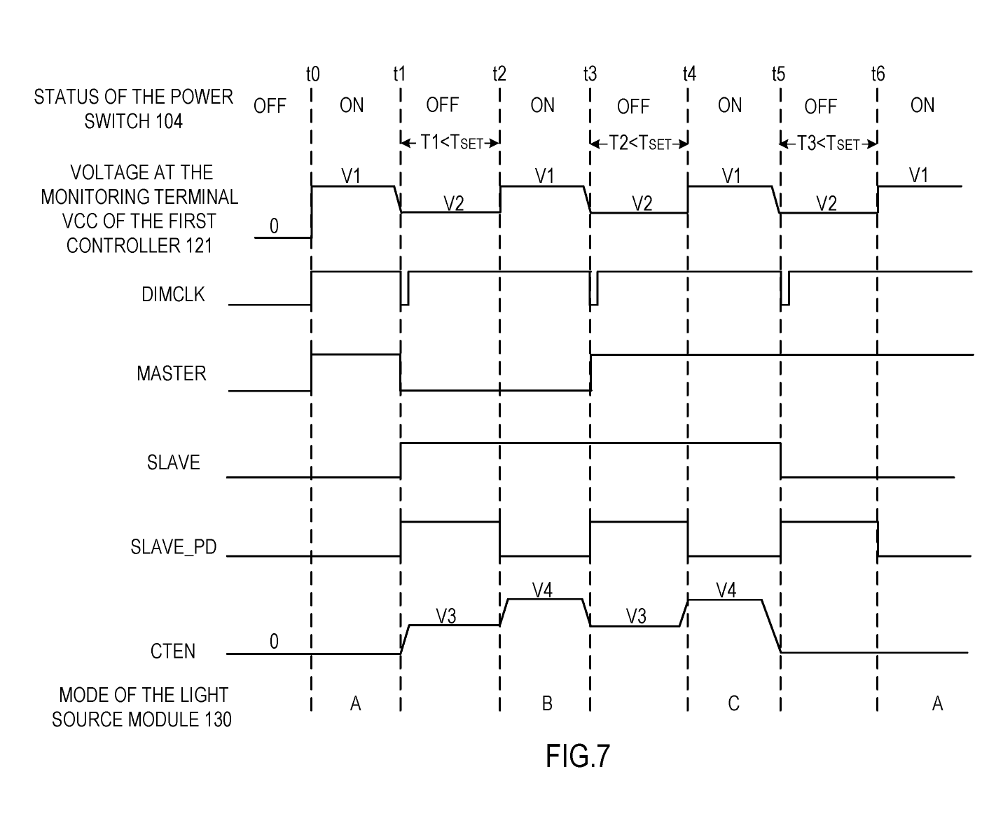

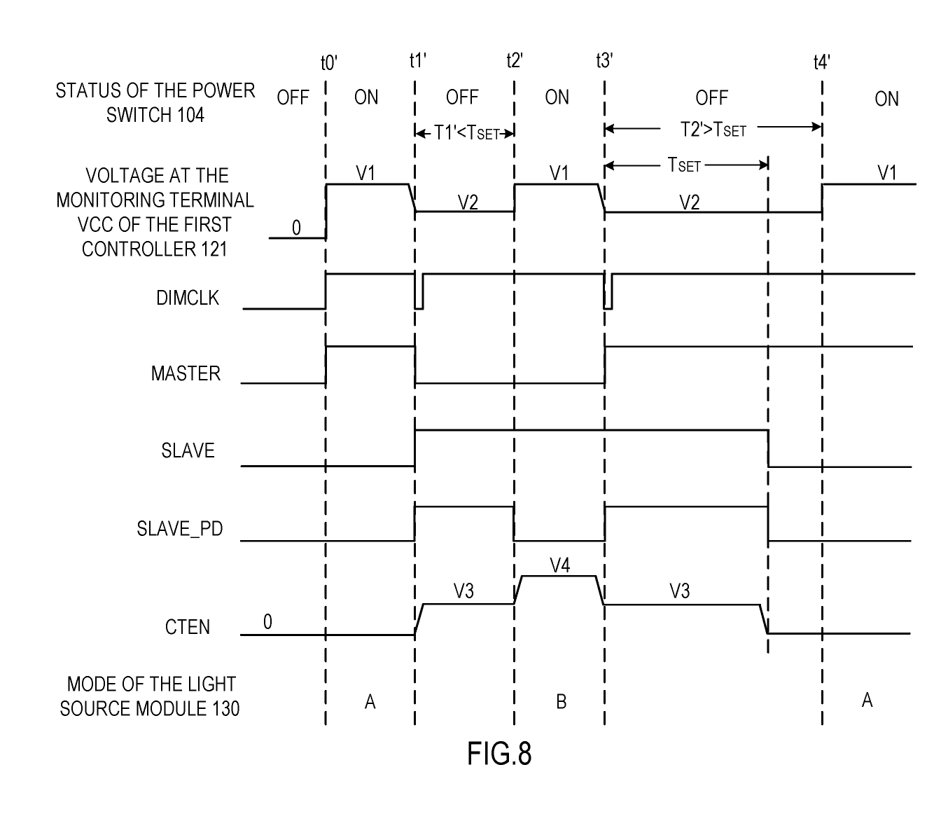

FIG. 6 shows a diagram illustrating the cascade control unit 408, in accordance with an embodiment of the present invention. In the embodiment of FIG. 6, the cascade control unit 408 includes a resistor R3 and a first transistor M1, which are coupled between the control terminal CTR and ground, and also includes a clamp circuit 604 coupled in parallel with the first transistor M1. The first transistor M1 is controlled by the second control signal SLAVE. The clamp circuit 604 includes a second transistor M2, a third transistor M3, and a diode D1 which are connected in series. The second transistor M2 is controlled by a signal SLAVE_PD. The signal SLAVE_PD is generated by the starting unit 304 and has two states: a high level and a low level. The initial state of the signal SLAVE_PD is the low level. Each time the power switch 104 is turned on or turned off again after the power switch 104 is turned off for the first time, the starting unit 304 changes the state of the signal SLAVE_PD. If, after the power switch 104 is turned off, it is turned on again after the preset time period expires (e.g., the timing signal TM is in the second state, such as the high level), then the signal SLAVE_PD is reset to the initial state (e.g., the low level). The cascade control unit 408 further includes a comparator 602. The negative terminal of the comparator 602 receives a reference voltage VREF1, and the positive terminal of the comparator 602 is coupled to the control terminal CTR through a voltage divider circuit including a resistor R1 and a resistor R2. The comparator 602 outputs a signal SLAVE_OK to the starting unit 304. The signal SLAVE_OK indicates whether the first controller 121 allows the second controller 122 to start. The operational principle of the cascade control unit 408 is described in conjunction with FIG. 7 and FIG. 8.

FIG. 7 shows a diagram illustrating operation of a light source driving circuit, in accordance with an embodiment of the present invention. FIG. 7 is described with reference also to FIG. 5 and FIG. 6. FIG. 7 shows the state of the power switch 104, the voltage at the monitoring terminal VCC of the first controller 121, the trigger signal DIMCLK, the first control signal MASTER, the second control signal SLAVE, the signal SLAVE_PD, the enable signal CTEN, and the mode of the light source module 130. In the example of FIG. 7, the power switch 104 is turned on for the first time at time t₀, turned off for the first time at time t₁, turned on for the second time at time t₂, turned off for the second time at time t₃, turned on for the third time at time t₄, turned off for the third time at time t₅, turned on for the fourth time at time t₆. In this example, a time interval T1 between time t₁ and time t₂, a time interval T2 between time t₃ and time t₄, and a time interval T3 between time t₅ and time t₆ are all less than a preset time period T_{SET}.

When the power switch 104 is turned on for the first time at time t₀, the voltage at the monitoring terminal VCC increases to V1 and the first controller 121 is turned on. The trigger signal DIMCLK is at a high level, the first control signal MASTER output by the logic unit 406 of FIG. 5 is at a high level, and the second control signal SLAVE is at a low level. Referring to FIG. 6, the signal SLAVE_PD is at a low level, the second transistor M2 is turned off, the second control signal SLAVE is at a low level, and the first transistor M1 is turned on accordingly. The control terminal CTR is connected to ground through the first transistor M1, so the enable signal CTEN is in the first state, e.g., the voltage is 0 V. The voltage at the power terminal VCC of the second controller 122 is pulled down, and the second controller 122 is turned off accordingly. The voltage VD at the positive terminal of the comparator 602 is less than the reference signal VREF1, and the signal SLAVE_OK output by the comparator 602 is at a low level. From time t₀ to time t₁, the first control signal MASTER is at a high level and the first light source 110 is turned on accordingly, the second controller 122 is turned off such that the second light source 120 is turned off, and the light source module 130 is in mode A.

At time t₁, the power switch 104 is turned off, the voltage at the monitoring terminal VCC decreases from V1 to V2, a negative pulse appears in the trigger signal DIMCLK, and the signal SLAVE_PD changes to a high level. The first control signal MASTER output by the logic unit 406 of FIG. 5 changes to a low level, and the second control signal SLAVE changes to a high level. Referring to FIG. 6, when the signal SLAVE_PD is at a high level and the second control signal SLAVE is at a high level, the clamp circuit 604 clamps the voltage of the enable signal CTEN to the intermediate voltage V3 (e.g., 7 V). The intermediate voltage V3 is less than the starting voltage at the second controller 122, and the second controller 122 is turned off. The voltage VD at the positive terminal of the comparator 602 is less than the reference signal VREF1, and the signal SLAVE_OK output by the comparator 602 is at a low level.

At time t₂, the power switch 104 is turned on, and the signal SLAVE_PD changes to a low level. Referring to FIG. 6, when the signal SLAVE_PD is at a low level and the second control signal SLAVE is at a high level, the voltage of the enable signal CTEN is pulled up to the voltage V4. From time t₂ to time t₃, the voltage V4 is greater than a starting voltage at the second controller 122, so the second controller 122 is turned on and the second light source 120 is turned on. During this time period, the first control signal MASTER is at a low level, the first light source 110 is turned off, and the light source module 130 is in mode B.

At time t₃, the power switch 104 is turned off, a negative pulse appears in the trigger signal DIMCLK, the signal SLAVE_PD changes to a high level, the first control signal MASTER output by the logic unit 406 in FIG. 5 changes to a high level, and the second control signal SLAVE is at a high level. Referring to FIG. 6, when the signal SLAVE_PD is at a high level and the signal SLAVE is at a high level, the clamp circuit 604 clamps the voltage of the enable signal CTEN to the intermediate voltage V3. The voltage VD at the positive terminal of the comparator 602 is less than the reference signal VREF1, and the signal SLAVE_OK output by the comparator 602 is at a low level.

At time t₄, the power switch 104 is turned on, and the signal SLAVE_PD changes to a low level. The first control signal MASTER output by the logic unit 406 of FIG. 5 is at a high level, and the second control signal SLAVE is at a high level. Referring to FIG. 6, when the signal SLAVE_PD is at a low level and the second control signal SLAVE is at a high level, the voltage of the enable signal CTEN is pulled up to the voltage V4. The voltage V4 is greater than the starting voltage at the second controller 122, and the second controller 122 is turned on accordingly. From time t₄ to time t₅, the first control signal MASTER is at a high level and the first light source 110 is turned on accordingly, the second controller 122 is started and the second light source 120 is turned on accordingly, and the light source module 130 is in mode C.

At time t₅, the power switch 104 is turned off, a negative pulse appears in the trigger signal DIMCLK, the signal SLAVE_PD changes to a high level, and the second control signal SLAVE output by the logic unit 406 of FIG. 5 changes to a low level. Referring to FIG. 6, when the signal SLAVE_PD is at a high level and the second control signal SLAVE is at a low level, the voltage of the enable signal CTEN is 0 V. The voltage VD at the positive terminal of the comparator 602 is less than the voltage of the reference signal VREF1, and the signal SLAVE_OK output by the comparator 602 is at a low level.

At time t₆, the power switch 104 is turned on, the signal SLAVE_PD becomes a low level, the first control signal MASTER output by the logic unit 406 of FIG. 5 is at a high level, and the second control signal SLAVE is at a low level. Referring to FIG. 6, when the signal SLAVE_PD is at a low level and the second control signal SLAVE is at a low level, the voltage of the enable signal CTEN is 0 V. The voltage VD at the positive terminal of the comparator 602 is less than the voltage of the reference signal VREF1, and the signal SLAVE_OK output by the comparator 602 is at a low level. The first control signal MASTER is at a high level and the first light source 110 is turned on accordingly, the second controller 122 is turned off and the second light source 120 is turned off accordingly, and the light source module 130 is in mode A.

FIG. 8 shows a diagram illustrating operation of a light source driving circuit, in accordance with an embodiment of the present invention. FIG. 8 is described with reference to FIG. 5 and FIG. 6. In this example, the power switch 104 is turned on at time t₀′, turned off at time t₁′, and turned on again at time t₂′, and a time interval T1′ between time t₁′ and time t₂′ is less than the preset time period T_{SET}. Similar to the operation illustrated in FIG. 7, the light source mode 130 changes from mode A to mode B. In contrast to the example of FIG. 7, in the example of FIG. 8, the power switch 104 is turned off at time t₃′ and turned on at time t₄′, and a time interval T2′ between time t₃′ and time t₄′ is greater than the preset time period T_{SET}. When the preset time period T_{SET} expires, the timing signal TM changes to the second state (e.g., a high level), the signal SLAVE_PD is reset to the initial state (e.g., a low level). Referring to FIG. 5, when the timing signal TM changes from a low level to a high level, the first control signal MASTER output by the logic unit 406 of FIG. 5 is at a high level, and the second control signal SLAVE is at a low level. Referring to FIG. 6, when the signal SLAVE_PD is at a low level and the second control signal SLAVE is at a low level, the voltage of the enable signal CTEN is 0 V. The voltage VD at the positive terminal of the comparator 602 is less than the voltage of the reference signal VREF1, and the signal SLAVE_OK output by the comparator 602 is at a low level. Therefore, when the power switch 104 is turned on again at time t₄′, the first control signal MASTER is at a high level and the first light source 110 is turned on accordingly, the second controller 122 is turned off and the second light source 120 is turned off accordingly, and the light source module 130 is reset to mode A (e.g., the default mode).

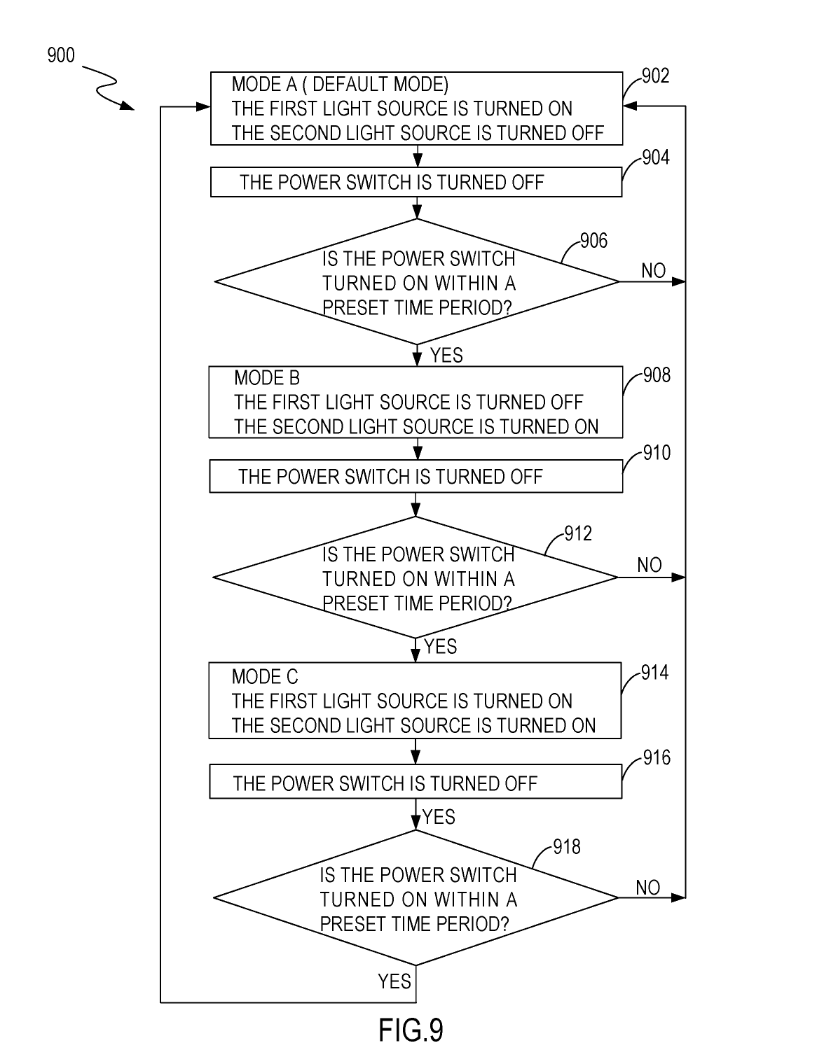

FIG. 9 shows a flowchart 900 of a method for controlling power of a light source module (e.g., the light source module 130 of FIG. 1), in accordance with an embodiment of the present invention. In step 902, the light source mode 130 is in mode A (e.g., the default mode). In mode A, the first light source 110 in the light source module 130 is turned on and the second light source 120 is turned off.

In step 904, a power switch (e.g., the power switch 104 of FIG. 1) is turned off. In step 906, a determination is made as to whether the power switch 104 is turned on within a preset time period T_{SET}. If yes, the flowchart goes to step 908, and the light source module 130 is switched to mode B. In mode B, the first light source 110 in the light source module 130 is turned off, and the second light source 120 is turned on. If no, the flowchart goes to step 902, and the mode of the light source module 130 is reset to the default mode, e.g., mode A.

In step 910, the power switch is turned off. In step 912, a determination is made as to whether the power switch 104 is turned on within the preset time period T_{SET}. If yes, the flowchart goes to step 914, and the mode of the light source module 130 is switched to mode C. In mode C, the first light source 110 in the light source module 130 is turned on and the second light source 120 is turned on. If no, the flowchart goes to step 902, and the mode of the light source module 130 is reset to the default mode, e.g., mode A.

In step 916, the power switch is turned off. In step 918, a determination is made as to whether the power switch 104 is turned on within the preset time period T_{SET}. If yes, the flowchart goes to step 902, and the light source module 130 is switched to mode A. If no, the flowchart goes to step 902, and the mode of the light source module 130 is reset to the default mode, e.g., mode A.

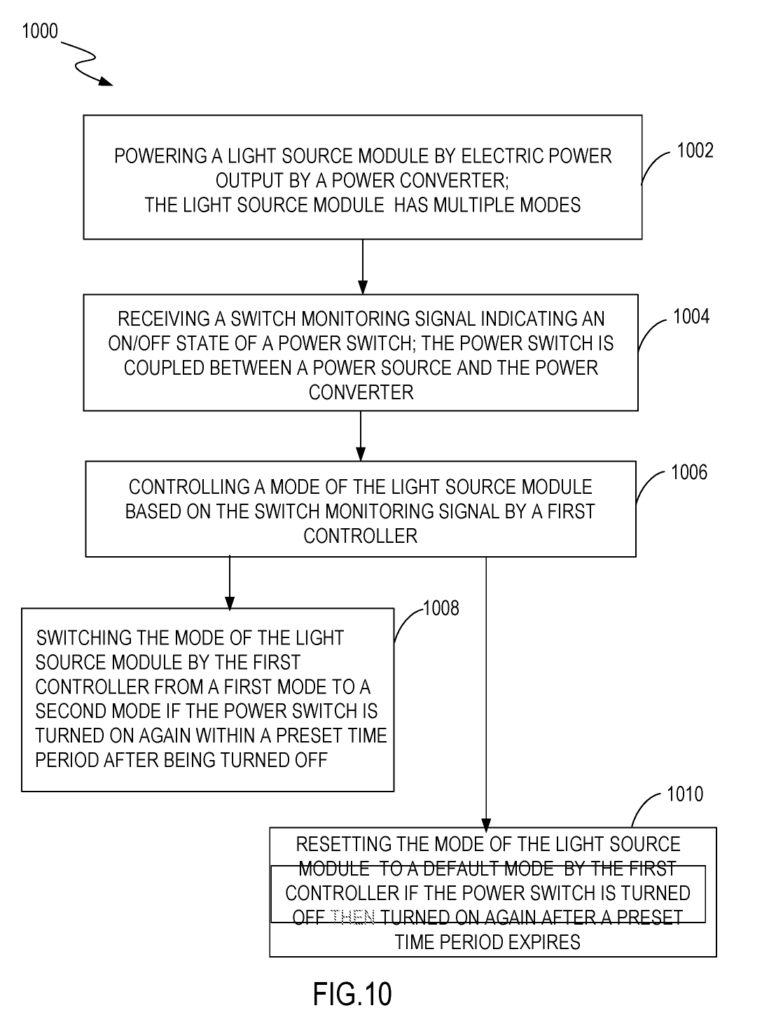

FIG. 10 shows a flowchart 1000 of a method for controlling power of a light source module, in accordance with an embodiment of the present invention. FIG. 10 is described with reference also to FIG. 1 and FIG. 2.

In step 1002, a light source module (e.g., the light source module 130 in FIG. 1) is powered by a power converter (e.g., the first power converter 108 or the second power converter 109). The light source module can be in one of multiple modes when and while it is turned on.

In step 1004, a first controller 121 receives a switch monitoring signal VSTART. The switch monitoring signal VSTART indicates an on/off state of the power switch 104. The power switch 104 is coupled between a power source 102 and the power converter.

In step 1006, the first controller 121 controls the mode of the light source module 130 based on the switch monitoring signal VSTART.

In step 1008, when the power switch 104 is turned off then turned on again within a preset time period T_{SET}, the light source module 130 is changed from a first mode to a second mode according to a predetermined order by the first controller 121.

In step 1010, when the power switch 104 is turned off then turned on again after the preset time period T_{SET} expires, the light source module 130 is reset to a default mode by the first controller 121.

As described above, embodiments of the present invention disclose a controller for controlling a light source, a light source driving circuit, and a method for controlling a light source module. The present invention can adjust the mode of the light source module using an on/off power switch to adjust the color or brightness of the light source module without the need to use an additional dimming device, thus reducing cost.

While the foregoing description and drawings represent embodiments of the present invention, it will be understood that various additions, modifications, and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A controller, coupled to a first light source in a light source module through a power converter, said controller comprising:
a monitoring terminal coupled to a power switch, operable for receiving a switch monitoring signal indicating an on/off state of said power switch, wherein said power switch is coupled between a power source and a rectifier, wherein said power converter is operable for receiving input electric power from said rectifier and for supplying output electric power to said first light source; and
a control terminal, operable for outputting an enable signal based on said switch monitoring signal to control a second controller coupled to a second light source in said light source module, said second controller operable to turn on said second light source, said second controller also operable to turn off said second light source.

2. The controller of claim 1, wherein said enable signal is applied to a power terminal of said second controller, and wherein when said enable signal is in a first state, then a voltage at said power terminal of said second controller is pulled down and said second controller is turned off.

3. The controller of claim 1, wherein said controller comprises:
a mode control unit coupled to said monitoring terminal and said control terminal, operable for generating said enable signal based on said switch monitoring signal, said mode control unit comprising:
a trigger monitoring unit, operable for generating a trigger signal based on said switch monitoring signal;
a timer, operable for recording a time interval between a time said power switch is turned off and a time said power switch is turned on again based on said switch monitoring signal, and operable for generating a timing signal; and
a logic unit, operable for generating a first control signal and a second control signal based on said trigger signal and said timing signal;
wherein said first control signal controls an on/off state of said first light source, and said second control signal controls an on/off state of said second controller.

4. The controller of claim 3, wherein said light source module has a plurality of modes, and wherein when said power switch is turned on again within a preset time period after being turned off, then said logic unit regulates said first control signal and said second control signal to switch a mode of said light source module from a first mode to a second mode.

5. The controller of claim 3, wherein said light source module has a plurality of modes, and wherein when said power switch is turned off then turned on again after a preset time period expires, then said logic unit regulates said first control signal and said second control signal to reset said mode of said light source module to a default mode of said plurality of modes.

6. The controller of claim 3, wherein said mode control unit comprises:
a cascade control unit, operable for generating said enable signal based on said second control signal, said cascade control unit comprising:
a first transistor coupled between said control terminal and ground; and
a clamp circuit coupled in parallel with said first transistor.

7. The controller of claim 6, wherein said clamp circuit comprises a second transistor, a third transistor, and a diode, wherein said second transistor, said third transistor, and said diode are coupled in series.

8. A light source driving circuit, comprising:
a light source module, comprising a first light source and a second light source, wherein said light source module has a plurality of modes;
a first power converter, operable for receiving input electric power from a rectifier and for supplying output electric power to said first light source;
a second power converter, operable for receiving input electric power from said rectifier and for supplying output electric power to said second light source;
a first controller coupled to said first power converter, wherein said first controller is operable for: controlling said first light source by controlling said first power converter, receiving a switch monitoring signal indicating an on/off state of a power switch, and controlling a mode of said light source module based on said switch monitoring signal,
a second controller coupled to said second power converter, wherein said second controller is operable for controlling said second light source by controlling said second power converter, wherein an on/off state of said second controller is determined by an enable signal output by said first controller.

9. The light source driving circuit of claim 8, wherein said power switch is turned on again within a preset time period after being turned off, then said first controller switches said mode of said light source module from a first mode to a second mode; and wherein when said power switch is turned off then turned on again after a preset time period expires, then said first controller resets said mode of said light source module to a default mode of said plurality of modes.

10. The light source driving circuit of claim 8, wherein said first controller comprises:
a monitoring terminal coupled to said power switch, operable for receiving said switch monitoring signal; and
a control terminal, operable for outputting said enable signal to control said second controller based on said switch monitoring signal, said second controller operable to turn on said second light source, said second controller also operable to turn off said second light source.

11. The light source driving circuit of claim 10, wherein said enable signal is applied to a power terminal of said second controller, and wherein when said enable signal is in a first state, then a voltage at said power terminal of said second controller is pulled down and said second controller is turned off.

12. The light source driving circuit of claim 10, wherein said first controller further comprises:
a mode control unit coupled to said monitoring terminal and said control terminal, and operable for generating said enable signal based on said switch monitoring signal, said mode control unit comprising:
a trigger monitoring unit, operable for generating a trigger signal based on said switch monitoring signal;
a timer, operable for recording a time interval between a time said power switch is turned off and a time said power switch is turned on again based on said switch monitoring signal, and for generating a timing signal accordingly; and
a logic unit, operable for generating a first control signal and a second control signal based on said trigger signal and said timing signal;
wherein said first control signal controls an on/off state of said first light source, and said second control signal controls an on/off state of said second controller.

13. The light source driving circuit of claim 12, wherein said mode control unit further comprises:
a cascade control unit, operable for generating said enable signal based on said second control signal, said cascade control unit comprising:
a first transistor coupled between said control terminal and ground; and
a clamp circuit coupled in parallel with said first transistor.

14. The light source driving circuit of claim 13, wherein said clamp circuit comprises:
a second transistor, a third transistor, and a diode, wherein said second transistor, said third transistor, and said diode are coupled in series.

15. A method for controlling a light source module, wherein said light source module comprises a first light source and a second light source, said method comprising:
powering said light source module by electric power output by a power converter, wherein said light source module has a plurality of modes;
receiving a switch monitoring signal indicating an on/off state of a power switch by a first controller, wherein said power switch is coupled between a power source and said power converter;
controlling a mode of said light source module based on said switch monitoring signal by said first controller;
switching said mode of said light source module by said first controller from a first mode to a second mode when said switch monitoring signal indicates that said power switch is turned on again within a preset time period after being turned off; and
resetting said mode of said light source module by said first controller to a default mode of said plurality of modes when said switch monitoring signal indicates that said power switch is turned off then turned on again after said preset time period expires.

16. The method of claim 15, further comprising:
controlling an on/off state of said first light source according to said switch monitoring signal by said first controller; and
outputting an enable signal operable for turning on and turning off a second controller coupled to said second light source by said first controller based on said switch monitoring signal, to turn on and turn off said second light source.

17. The method of claim 16, further comprising:
pulling down a voltage at a power terminal of said second controller to turn off said second controller when said enable signal is in a first state.
